(19) United States
(12) Patent Application Publication
(10) Pub. No.: US 2011/0192134 A1
(43) Pub. Date: Aug. 11, 2011

(54) AIR INTAKE STRUCTURE FOR A TURBINE ENGINE NACELLE

(75) Inventors: Guy Bernard Vauchel, Harfleur (FR); Fabien Bravin, St. Genies Bellevue (FR)

(73) Assignee: AIRCELLE, Gonfreville L'Orcher (FR)

(21) Appl. No.: 13/122,888

(22) PCT Filed: Jul. 21, 2009
(86) PCT No.: PCT/FR09/00893

§ 371 Date: Apr. 6, 2011

(30) Foreign Application Priority Data
Oct. 8, 2008 (FR) 08/5553

(51) Int. Cl. F02K 3/02

(52) U.S. Cl. 60/226.1

(57) ABSTRACT

The invention relates to an air intake structure (4) for a turbine engine nacelle for directing an air flow towards the fan of the turbine engine, said structure comprising at least one outer panel (40), at least one inner panel (41) and an air intake lip (4a) having an inner wall (70) to be in contact with the air flow flowing into the turbine engine and a partition (45) separating the air intake lip (4a) from the rest of the nacelle, the air intake lip (4a) having an extension (60) that can be fastened onto the inner panel (41) and that extends substantially as a continuation of the inner wall (70) towards the downstream side of the air intake structure over a length (I) at least equal to about the maximum distance (d) between the partition (45) and the air intake lip (4a). The invention also relates to a nacelle for a turbine engine comprising such an air intake structure (4).

### TECHNICAL FIELD

The invention relates to a nacelle for a turbojet engine.

### BACKGROUND

In general, an aircraft nacelle has a structure comprising an air intake structure, a middle structure and a downstream section. The term “downstream” here refers to the direction corresponding to the direction of the cold air flow penetrating the turbojet engine. The term “upstream” designates the opposite direction.

The air intake structure is situated upstream of the turbojet engine serving to propel the aircraft. Downstream of the air intake structure, the middle structure is intended to surround a fan of the turbojet engine. Still further downstream is the downstream section generally housing thrust reverser means intended to surround the combustion chamber of the turbojet engine. The nacelle ends with a jet nozzle whereof the outlet is situated downstream of the turbojet engine.

The air intake structure comprises at least one outer panel, at least one inner panel and an air intake lip having an inner wall intended to be in contact with the air flow penetrating the turbojet engine. Generally, the outer panel(s) extend the air intake lip. In other words, generally, the outer panels are not fastened on the air intake lip.

However, the air intake lip is removably fixed on inner panel(s). Thus, the mobile structure including an air intake lip and the outer panel(s) is able to move relative to a fixed structure including the inner panel(s). Such a mobile structure makes it possible to have access to the equipment housed inside the nacelle to perform maintenance thereof.

Moreover, the inner panel(s) can be provided with at least one acoustic panel, in particular a honeycomb structure, so as to absorb the noise annoyance resulting from the operation of the turbojet engine.

The nacelle also includes a partition generally fastened on the air intake lip, thereby defining a cavity in which cables or various devices are housed intended to ensure the operation of the nacelle, in particular means for deicing the air intake lip.

The middle structure is intended to surround the fan of the turbojet engine. Said structure is fastened to the air intake structure fixedly by the inner panel(s) and movably by the outer panels so as to ensure aerodynamic continuity.

To perform the maintenance operations on the equipment housed inside the air intake structure, the mobile structure is generally slid upstream of the middle structure by guide means. Generally, such guide means are in the form of a rail system.

Thus, in the opening position, i.e. when the air intake lip and the outer panel(s) are in the withdrawn upstream position, the operator has access to the inside of the nacelle. The operator can then perform the necessary maintenance operations.

Under flight conditions, the air intake structure is in the closed position, i.e. the mobile structure is fixed on the inner panel(s) and on the middle structure.

Usually, the interface zone between the mobile structure and the fixed structure of the nacelles is situated near the partition. To that end, the air intake lip includes an interface device near the partition, typically in the form of an L-shaped downstream end configured to be fixed on an opposing complementary device belonging to an inner skin.

However, in the pre-flight phase, i.e. when the turbojet engine is in the stopped airplane acceleration phase, the air intake lip undergoes temperatures of up to about 400° C. Such a thermal stress creates a substantial expansion of the materials making up the air intake lip. The expansion causes a significant deformation thereof introducing a force pulling the mobile structure in the upstream direction. Significant play resulting in the interface zone greatly compromises the performance of the turbojet engine.

Moreover, generally, the inner panel(s) are made of a composite material. As a result, the latter parts undergo significant thermal stresses, which result in structural degradation.

### BRIEF SUMMARY

One aim of the present invention is to provide an air intake structure for a nacelle not having the aforementioned drawbacks.

To that end, according to a first aspect, the invention relates to an air intake structure for a turbojet engine nacelle intended to channel a flow of air towards a fan of the turbojet engine, including at least one outer panel, at least one inner panel and an air intake lip having an inner wall intended to be in contact with the flow of air penetrating the turbojet engine and a partition separating the air intake lip from the rest of the nacelle, remarkable in that the air intake lip includes an extension that can be fixed on the inner panel and extending substantially in the continuation of the inner wall in the downstream direction of the air intake structure over a length at least equal to about the maximum distance between the partition and the air intake lip.

The air intake structure of the invention includes an air intake lip whereof the inner wall has an extension beyond the partition, in the downstream direction of the air intake structure of the invention. As a result, the interface zone supported by said extension is also moved further downstream than that of the prior art. Thus, the interface zone then undergoes very little or no thermal stress and therefore deformation of the air intake lip, which makes it possible to avoid the presence of play in said zone.

In parallel, access to the equipment positioned inside the nacelle and the inner panel(s), in particular the acoustic shroud, is not impacted.

According to other characteristics of the invention, the air intake structure of the invention includes one or several of the following optional features, considered alone or according to all possible combinations:
the extension includes an interface element able to be fixed on a corresponding interface element fixed on the inner panel, which makes it possible to removably fix the air intake lip to the inner panel;
the extension is fastened on the inner wall of the air intake lip, which makes it possible to use the usual air intake lips;
the extension is a cellular core structural panel that improves the mechanical resistance of the extension;
the structural panel is acoustic, which makes it possible to increase the acoustic area and thus the acoustic performance of the nacelle;
the extension is a substantially continuous prolongation of the inner wall of the air intake lip, which makes it possible to facilitate the assembly of the air intake structure;
the inner wall and the extension are cellular core structural panels, which makes it possible to increase the acoustic surface of the air intake structure;
a reinforcing partition is fastened on the extension at the interface zone with the inner panel, which makes it possible to reinforce the structural resistance of the mobile structure while limiting the associated mass gain.

According to another aspect, the invention relates to a nacelle for a turbojet engine including an air intake structure according to the invention.

### BRIEF DESCRIPTION OF THE DRAWINGS

The invention will be better understood upon reading the following non-limiting description, done in reference to the appended figures.

FIG. 1 is a perspective illustration of a nacelle including an air intake structure of the invention in the open position,

FIG. 2 is a partial longitudinal cross-section of an air intake structure according to the invention in the closed position,

FIG. 3 is a partial longitudinal cross-section of the air intake structure of the embodiment of FIG. 2 in the open position,

FIG. 4 is a partial longitudinal cross-section of an alternative of the air intake structure of FIG. 2 in the closed position,

FIG. 5 is a partial longitudinal cross-section of another alternative of the air intake structure of FIG. 2 in the open position,

FIG. 6 is a partial longitudinal cross-section of another alternative of the air intake structure of FIG. 2 in the closed position.

### DETAILED DESCRIPTION

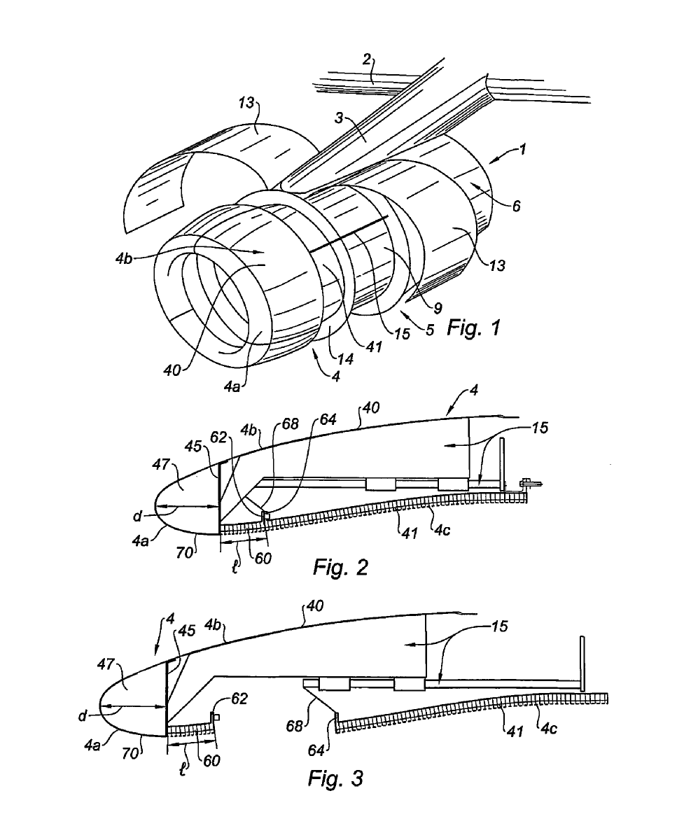

According to the embodiment illustrated in FIG. 1, a nacelle 1 including an air intake structure according to the invention constitutes a tubular housing for a turbojet engine (not shown) for which it serves to channel the flows of air it generates by defining the inner and outer aerodynamic lines necessary to obtain optimal performance. It also houses different components necessary for the operation of the turbojet engine as well as related systems such as a thrust reverser.

The nacelle 1 is intended to be attached to a fixed structure of an airplane, such as a wing 2, via a pylon 3.

More precisely, the nacelle 1 has a structure comprising an air intake structure 4 of the invention upstream, a middle structure 5 surrounding a fan (not shown) of the turbojet engine, and a downstream section 6 surrounding the turbojet engine and generally housing a thrust reverser system (not shown).

The middle structure 5 includes a casing 9 fastened to an end of the air intake structure 4 of the invention so as to ensure aerodynamic continuity.

The air intake structure 4 of the invention is divided into three zones. The first zone furthest upstream is an air intake lip 4a adapted to allow optimal collection towards the turbojet engine of the air necessary to supply the fan and the inner compressors of the turbojet engine. The second zone is a section 4b connected to an end of the air intake lip 4a comprising at least one outer panel 40. The third zone is a section 4c connected to the other end of the air intake lip 4a and including at least one inner panel 41.

The inner panel(s) 41 is(are) intended to suitably channel the air towards the vanes (not shown) of the fan. The inner panel(s) 41 are thus fixed at their downstream end to an upstream end of the casing 9 via fixing clips. Thus, the inner panel(s) 41 form(s), with the middle structure 5, a fixed structure relative to the nacelle 1. Moreover, the inner panel(s) 41 can comprise an acoustic shroud intended to attenuate the noise annoyance due to the operation of the turbojet engine and the vibrations of the structure. The acoustic shroud is typically made up of a honeycomb structure or any other structure known by those skilled in the art, making it possible to absorb the noise annoyance.

Typically, the inner panel(s) 41 are made from a composite material with carbon, even aluminum.

According to the invention, the air intake lip 4a is fixed to the outer panel(s) 40 so as to form a single disassemblable piece, called mobile structure. To that end, the air intake lip 4a can be incorporated into the outer panel(s) 40.

Typically, the outer panel(s) 40 are made from a composite material with carbon, even aluminum.

Typically, the air intake lip 4a is made from aluminum, titanium, or any other high-temperature composite material known by those skilled in the art.

In order to allow the mobile structure to withdraw upstream of the nacelle 1, the latter part is typically provided with guiding means 15 able to allow a substantially rectilinear movement of the outer panel(s) 40 in the upstream direction of the nacelle 1 so as to be able to open the air intake structure 4 for maintenance issues. Examples of rail systems include the rail systems described in application FR 2 906 568, such as travelers on rails, a rail in a groove able to cooperate with a guideway system, a system of roller skids able to cooperate with a corresponding rail, and a longitudinal axis able to slide through a corresponding opening.

The air intake structure 4 of the invention also includes a partition 45 separating the air intake lip 4a from the rest of said air intake structure 4. The partition 45 thus makes it possible to delimit a cavity 47 within which equipment, such as deicing equipment, is arranged to ensure the operation of the nacelle 1.

In a longitudinal cross-section of the air intake structure 4 of the invention, the partition 45 and the air intake lip 4a are separated by a maximum distance d. The maximum distance d corresponds, here, to the distance separating the point of the air intake lip 4a furthest from the partition 45 in a longitudinal cross-section. Typically, the maximum distance d corresponds to the length of the cavity 47.

Typically, the partition 45 is made of aluminum, titanium, or any high-temperature composite material known by those skilled in the art.

The air intake lip 4a also includes an extension 60 able to be fixed on the inner panel 41 extending beyond the partition 45, substantially in the continuation of the inner wall 70, over a length l at least equal to about the maximum distance d between the partition 45 and the air intake lip 4a.

Inasmuch as the extension 60 extends in the downstream direction of the air intake structure of the invention and more generally of the nacelle 1, the interface zone between the inner panels 41 and the extension 60 does not undergo any further deformation, or very little deformation, of the air intake lip 4a. Thus, said zone has little or no play between the inner panel 41 and the extension 60. The absence of play then ensures more substantial longevity of the air intake structure 4 than that of the prior art and guarantees a lower risk of rupture of the fixing zone when the aircraft is in flight. Moreover, the aerodynamic performance due to the continuity of the lines is not impacted.

Moreover, there is no longer any play caused by the thermal deformation of the air intake lip 4a at said interface zone, which makes it possible to preserve good fixing when the aircraft is in flight.

The extension 60 typically has a length l between 50 mm and 400 mm, or between 150 mm and 300 mm, in particular equal to about 200 mm. Such a length l ensures an extension 60 having an interface subject to little or no deformation of the air intake lip 4a.

Moreover, the extension 60 is typically made from aluminum, or a carbon composite material.

According to the preferred embodiment shown in FIGS. 2 and 3, the extension 60 is fastened on the inner wall 70 of the air intake lip 4a, which makes it possible to use the usual air intake lips 4a known by those skilled in the art. The extension 60 is for example fastened by splicing or any other means known by those skilled in the art.

In this case, the extension 60 can advantageously be a cellular core structural panel, which further improves the mechanical resistance of the extension 60.

Preferably, the structural panel is acoustic, which makes it possible to increase the acoustic surface and thereby the acoustic performance of the nacelle 1.

The acoustic treatment of the inner panel 41 and of the extension 60 can be different in order to better absorb the noise annoyance. To obtain different impedances, it is possible to modify certain parameters of the acoustic panel, such as the depth of the acoustic cells, the number of cellular layers, the diameter of the acoustic holes. It is also possible to provide a transition zone between the two acoustic treatments.

According to one preferred embodiment, the extension 60 includes an interface element 62 able to be fixed on a corresponding interface element 64 fixed on the inner panel 41, which makes it possible to removably fix the air intake lip 4a to the inner panel 41. Typically the interface device 64 is mounted substantially opposite the interface device 62 and has a shape substantially complementary to said interface element 62.

The interface elements 62 and 64 are all interface elements known by those skilled in the art. The interface elements 62 and 64 can also fill the role of centering the mobile structure on the fixed structure. To that end, we can cite rigid centering means, such as centering pins able to cooperate with corresponding bores, and/or flexible to ensure structural continuity, such as an elastic tab. In the case an elastic tab is used, it is situated in the prolongation of the extension 60. Examples of an elastic tab include those described in international application WO 2008/040877.

Examples of means for centering the extension 60 and the inner panel 41 include those described in application FR 2 906 568.

The interface device 62 can be fastened on the downstream end of the surface of the extension 60 and oriented towards the inside of the air input structure 4 of the invention. In one alternative, the interface device 62 is a prolongation of the downstream end of the extension 60.

The structure of the guide means 15 can protrude past the upstream interface of the inner panel 41. If it is necessary to link the end of said structure protruding past the inner panel 41, it is possible to fix a connection 68 on the interface device 64 of the inner panel or on the non-acoustic skin of said panel 41 that is oriented towards the inside of the air intake structure 4. The connection 68 used can be of any type known by those skilled in the art and adapted to that application. Examples include a support clip connection.

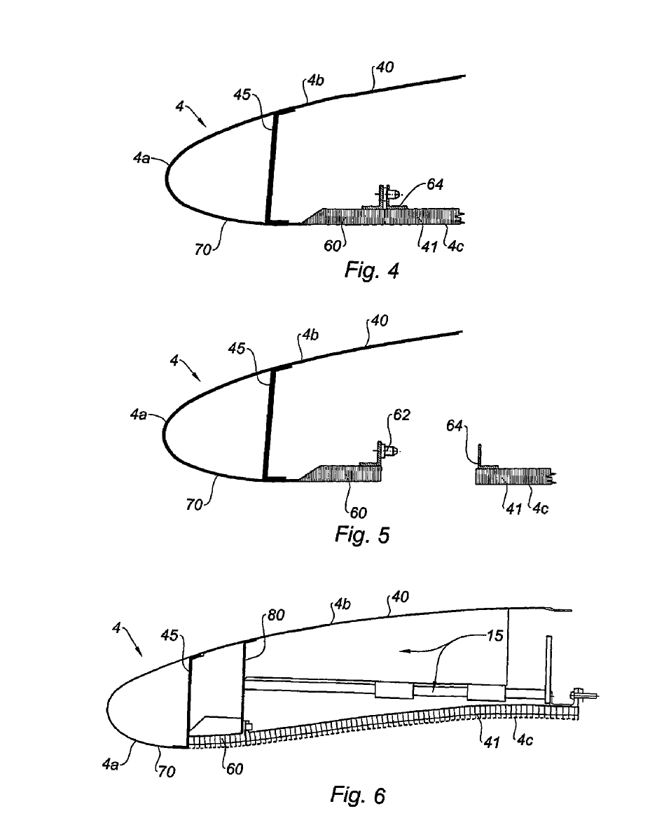

According to the preferred embodiment shown in FIG. 4, the inner wall 70 extends continuously in the extension 60, which simplifies the mounting of the air intake structure 4 of the invention. In the case where the inner wall 70 is a metal sheet covered by an outer skin, the extension 60 is also a metal sheet covered with an outer skin. According to the embodiment shown in FIG. 5, the inner wall 70 and the extension 60 are cellular core structural panels, possibly acoustically treated. As indicated above, it is possible to provide an acoustic treatment of the extension 60 and of the inner wall 70 different from that of the inner skin 41. Likewise, the acoustic treatment of the inner wall 70 and the extension 60 can be different in order to obtain impedances with different values. It is thus possible to modify certain parameters of the acoustic panel such as the depth of the acoustic cells, the number of cellular layers, the diameter of the acoustic holes.

According to the embodiment illustrated in FIG. 6, a reinforcing partition 80 is fastened on the extension 60 at the interface zone with the inner panel 41, which makes it possible to reinforce the structural resistance of the mobile structure while limiting the associated mass gain. The reinforcing partition 80 is typically mounted downstream of and opposite the usual partition 45. As an example, the reinforcing partition 80 is made in a carbon acoustic material in order to substantially preserve the mass of the nacelle 1.

1. An air intake structure for a turbojet engine nacelle intended to channel a flow of air towards a fan of the turbojet engine, comprising:
at least one outer panel,
at least one inner panel and
an air intake lip having an inner wall intended to be in contact with a flow of air penetrating the turbojet engine and a partition separating the air intake lip from the rest of the nacelle,
wherein the air intake lip-includes an extension that can be fixed on the inner panel and extending substantially in continuation of the inner wall in a downstream direction of the air intake structure over a length at least equal to about a maximum distance between the partition and the air intake lip.

2. The air intake structure according to claim 1, wherein the extension includes an interface element able to be fixed on a corresponding interface element fixed on the inner panel.

3. The air intake structure according to claim 1, wherein the extension is fastened on the inner wall of the air intake lip.

4. The air intake structure according to claim 1, wherein the extension is a cellular core structural panel.

5. The air intake structure according to claim 4, wherein the structural panel is acoustic.

6. The air intake structure according to claim 1, wherein the extension is a substantially continuous prolongation of the inner wall of the air intake lip.

7. The air intake structure according to claim 6, wherein the inner wall and the extension are cellular core structural panels.

8. The air intake structure according to claim 1, wherein a reinforcing partition is fastened on the extension at an interface zone with the inner panel.

9. A nacelle for a turbojet engine including an air intake structure according to claim 1.
